(19) United States
(12) Patent Application Publication
(10) Pub. No.: US 2015/0176537 A1
(43) Pub. Date: Jun. 25, 2015

(54) EXHAUST GAS RECOVERY APPARATUS OF EGR COOLER FOR VEHICLE

(71) Applicant: Hyundai Motor Company, Seoul (KR)

(72) Inventor: Il JUNG, Suwon-si (KR)

(73) Assignee: Hyundai Motor Company, Seoul (KR)

(21) Appl. No.: 14/478,464

(22) Filed: Sep. 5, 2014

(30) Foreign Application Priority Data
Dec. 24, 2013 (KR) 10-2013-0162015

(51) Int. Cl. F02M 25/07

(52) U.S. Cl. CPC F02M 25/0731; F02M 25/0719

(57) ABSTRACT

Disclosed is an exhaust gas recovery apparatus of an EGR cooler for a vehicle that circulates some of exhaust gases cooled by an EGR cooler to be discharged, not to an engine but to the outside in a low load operation condition or in a winter season condition, and thus maintaining a temperature of engine cooling water high. The apparatus may include a branch pipe for transferring exhaust gases discharged from the EGR cooler to a turbo charger, a flow rate control valve installed in the branch pipe for adjusting a flow rate of the exhaust gases, and a control unit for controlling an opening degree of the flow rate control valve.

### CROSS-REFERENCE TO RELATED APPLICATION

The present application claims priority of Korean Patent Application Number 10-2013-0162015 filed on Dec. 24, 2013, the entire contents of which application are incorporated herein for all purposes by this reference.

### BACKGROUND OF INVENTION

1. Field of Invention

The present invention relates to an exhaust gas recovery apparatus of an exhaust gas recirculation (EGR) cooler for a vehicle by which some of exhaust gases in the EGR cooler mounted to the vehicle are recovered to be exhausted to the outside, and more particularly to an exhaust gas recovery apparatus of an EGR cooler for a vehicle that circulates some of exhaust gases cooled by an EGR cooler to be discharged, not to an engine but to the outside in a low load operation condition or in a winter season condition, thereby maintaining the engine cooling water at high temperature.

2. Description of Related Art

Exhaust gases of a vehicle contain toxic substances such as carbon monoxide (CO), nitrogen oxides (NOx), and hydrocarbon (HC), and among the substances generated in a combustion process, nitrogen oxides have an opposite relationship to monoxide and hydrocarbon.

That is, in a practical output range, a maximum amount of nitrogen oxides are generated at a time point when the amounts of monoxide and hydrocarbon decrease maximally, and a more amount of nitrogen oxides increases as a fuel is burned completely, i.e., as a temperature of the engine is high.

Thus, as an allowable amount of exhaust gases such as nitrogen oxides is regulated by rules, various technologies for reducing exhaust gases have been developed. One of the technologies is exhaust gas recirculation (EGR).

The exhaust gas recirculation apparatus supplies some of combustion gases (EGR gases) of mixed gases suctioned into a combustion chamber while maintaining a mixing ratio at a theoretical air fuel ratio to reduce an amount of generated nitrogen oxides without abruptly increasing an amount of other harmful substances, so that a temperature of flames can be lowered by reducing an amount of new air and increasing a thermal capacity of exhaust gases at the same time.

In more detail, the EGR apparatus is an apparatus for circulating exhaust gases into an intake system again to lower a combustion temperature in a cylinder and restrain generation of nitrogen oxides, and refers to an apparatus that returns some exhaust gases to an intake system to lower a maximum temperature when mixed gases are burned, thereby reducing an amount of generated nitrogen oxides (NOx) as a means for decreasing an amount of nitrogen oxides in the exhaust gases.

The EGR apparatus includes an EGR pipe for circulating some exhaust gases discharged from an exhaust manifold to an intake manifold again, and an EGR valve installed at a position of the EGR pipe, for adjusting an amount of circulated exhaust gases. In particular, the EGR apparatus includes an EGR cooler for cooling exhaust gases introduced through the EGR valve and sending the cooled exhaust gases to the intake manifold.

Among the elements of the EGR apparatus, the EGR cooler is a type of heat exchanger for cooling exhaust gases of a high temperature while taking engine cooling water as a coolant.

Thus, since the exhaust gas recirculation apparatus is used only for the purpose of reducing nitrogen oxides by lowering a combustion temperature of an engine in spite that exhaust heat can be recovered effectively, a maximum pressure (PM) increases and a nozzle hole of an injector is blocked when EGR is excessively generated in a winter season or a low load condition that requires recovery of exhaust heat actually, resulting in a limit in use thereof.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems and/or other problems. The present invention is directed to provide an exhaust gas recovery apparatus of an EGR cooler for a vehicle by which some of exhaust gases in the EGR cooler mounted to the vehicle are recovered to be exhausted to the outside, and more particularly to an exhaust gas recovery apparatus of an EGR cooler for a vehicle that circulates some of exhaust gases cooled by an EGR cooler to be discharged, not to an engine but to the outside in a low load operation condition or in a winter season condition, thereby maintaining a temperature of engine cooling water high.

In accordance with various aspects of the present invention, there is provided an exhaust gas recovery apparatus of an EGR cooler for a vehicle, the apparatus including: a branch pipe for transferring exhaust gases discharged from the EGR cooler to a turbo charger; a flow rate control valve installed in the branch pipe, for adjusting a flow rate of the exhaust gases; and a control unit for controlling an opening degree of the flow rate control valve.

The apparatus may further include: an EGR valve installed in an EGR exhaust gas pipe connected to the EGR cooler, for adjusting an amount of the exhaust gases circulated to the engine; a water temperature sensor for measuring a temperature of engine cooling water; a load detection sensor for measuring a load of the engine; and an atmosphere temperature sensor for measuring a temperature of the atmosphere. The water temperature sensor, the load detection sensor, and the atmosphere temperature sensor may provide the measured temperatures and load to the control unit.

The branch pipe may be branched from an EGR exhaust gas pipe and is connected to a front end or a rear end of the turbo charger.

The control unit may open the flow rate control valve only if all of an opening degree of the EGR valve, the temperature of the engine cooling water, the temperature of the atmosphere, and the load of the engine satisfy predetermined conditions.

In accordance with various other aspects of the present invention, there is provided an exhaust gas recovery apparatus of an EGR cooler for a vehicle, the apparatus including: a branch pipe for transferring exhaust gases discharged from the EGR cooler to a turbo charger; a direction control valve installed at a connection point of the branch pipe and an EGR exhaust gas pipe, for adjusting a flow direction of the exhaust gases; and a control unit for controlling an operation of the direction control valve.

The branch pipe may be branched from the EGR exhaust pipe and may be connected to a front end or a rear end of the turbo charger, and the control unit may control the operation of the direction control valve based on an EGR opening rate.

In accordance with still various other aspects of the present invention, there is provided an exhaust gas recovery apparatus of an EGR cooler for a vehicle, the apparatus including: a branch pipe for transferring exhaust gases discharged from the EGR cooler to a turbo charger; a direction control valve installed at a connection point of the branch pipe and an EGR exhaust gas pipe, for adjusting a flow direction of the exhaust gases; an opening/closing valve installed in the branch pipe, for controlling a flow of the exhaust gases; and a control unit for controlling an operation of the direction control valve and an operation of the opening/closing valve.

The apparatus may further include a water temperature sensor for measuring a temperature of engine cooling water. The water temperature sensor may provide the measured temperature to the control unit.

The control unit may open the opening/closing valve and control the operation of the direction control valve based on an EGR opening rate if a temperature of engine cooling water is equal to or less than a reference value.

According to the present invention, in the exhaust gas recovery apparatus of an EGR cooler for a vehicle, some of exhaust gases in the EGR cooler mounted to the vehicle are recovered to be exhausted to the outside, and more particularly to an exhaust gas recovery apparatus of an EGR cooler for a vehicle that circulates some of exhaust gases cooled by an EGR cooler to be discharged, not to an engine but to the outside in a low load operation condition or in a winter season condition, thereby maintaining a temperature of engine cooling water high.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a schematic diagram showing an exemplary exhaust gas recovery apparatus of an EGR cooler for a vehicle according to the present invention;

FIG. 2 is a block diagram showing exemplary constituent elements of an exemplary exhaust gas recovery apparatus of an EGR cooler for a vehicle according to the present invention;

FIG. 3 is a schematic diagram showing an exemplary exhaust gas recovery apparatus of an EGR cooler for a vehicle according to the present invention;

FIG. 4 is a flowchart showing an operation condition of an exemplary exhaust gas recovery apparatus of an EGR cooler for a vehicle according to the present invention;

FIG. 5 is a schematic diagram showing an exemplary exhaust gas recovery apparatus of an EGR cooler for a vehicle according to the present invention;

FIG. 6 is a schematic diagram showing an exemplary exhaust gas recovery apparatus of an EGR cooler for a vehicle according to the present invention;

FIG. 7 is a schematic diagram showing an exemplary exhaust gas recovery apparatus of an EGR cooler for a vehicle according to the present invention;

FIG. 8 is a schematic diagram showing an exemplary exhaust gas recovery apparatus of an EGR cooler for a vehicle according to the present invention; and

FIG. 9 is a flowchart showing an operation condition of an exemplary exhaust gas recovery apparatus of an EGR cooler for a vehicle according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention is adapted to recover exhaust gases of an EGR cooler in an engine system including a multi-step turbo, and aims to improve fuel ratio and engine operability by decreasing an amount of exhaust gases circulated to an engine again in an idle operation condition where EGR is not used, in a low load operation condition where a frequency of EGR is low, or in a winter season condition.

Accordingly, the present invention recovers some exhaust gases of the EGR cooler to a turbo charger and discharges the exhaust gases to the outside together with exhaust gases discharged from the turbo charger to decrease an amount of exhaust gases circulated to the engine again.

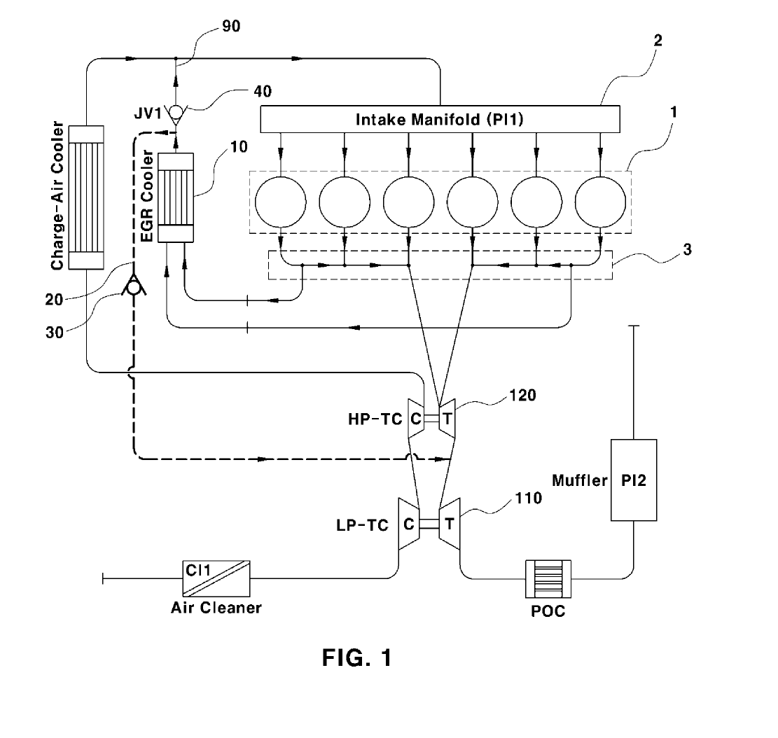

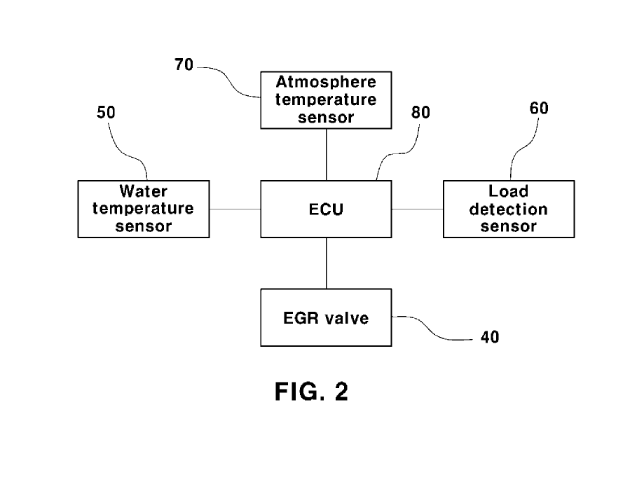

Referring to FIGS. 1 and 2, the exhaust gas recovery apparatus of an EGR cooler for a vehicle according to an embodiment of the present invention includes an EGR cooler 10, a branch pipe 20, a flow rate control value 30, an EGR valve 40, a water temperature sensor 50, a load detection sensor 60, an atmosphere temperature sensor 70, and a control unit 80.

The EGR cooler 10 is adapted to, if some exhaust gases discharged from an engine 1 are introduced into the EGR cooler 10, cool the exhaust gases and circulate the cooled exhaust gases into an engine 1 through an intake manifold 2, and is installed between a rear end of the engine 1 (e.g., an exhaust manifold 3) and a front end of the engine 1 (e.g., the intake manifold 2).

The branch pipe 20 is branched from an EGR exhaust gas pipe 90 and is connected to turbo chargers 110 and 120, and is adapted to transfer some of the exhaust gases discharged from the EGR cooler 10 to the turbo chargers 110 and 120.

As shown in FIG. 1, the branch pipe 20 is branched from the EGR exhaust gas pipe 90 between the EGR cooler 10 and the EGR valve 40 and is connected to a front end of a low pressure turbo charger 110 or a rear end of a high pressure turbo charger 120.

In detail, the branch pipe 20 is connected to turbines of the turbo chargers 110 and 120, and thus the exhaust gases transferred through the branch pipe 20 may be discharged to the outside together with the exhaust gases discharged from the turbines of the turbo chargers 110 and 120.

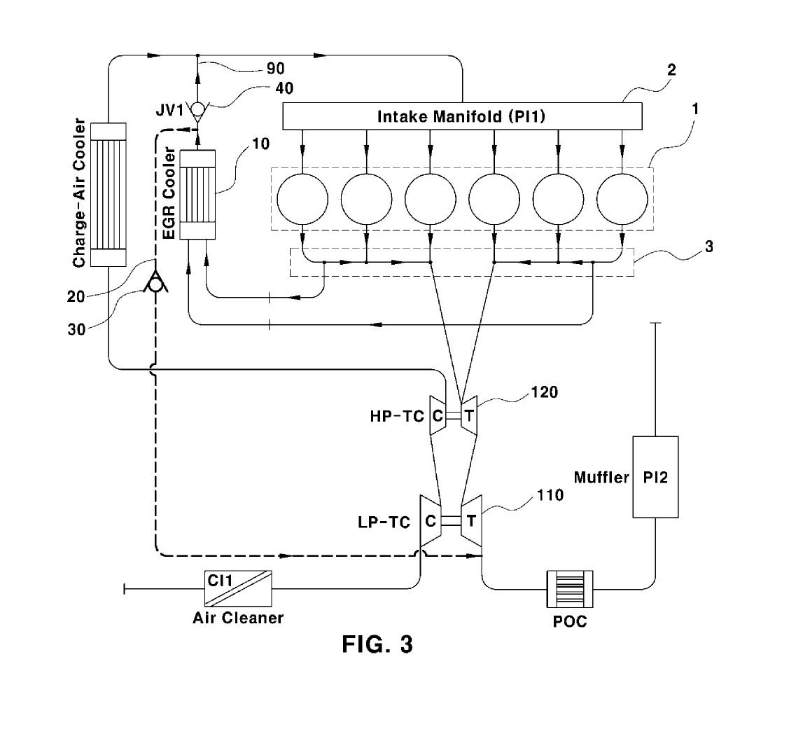

FIG. 3 shows an engine system including an exhaust gas recovery apparatus of an EGR cooler for a vehicle according to a second embodiment of the present invention. As shown, the branch pipe 20 may be branched from the EGR exhaust gas pipe 90 between the EGR cooler 10 and the EGR valve 40 and may be connected to a rear end of the low pressure turbo charger 110. The branch pipe 20 may be connected to the EGR exhaust gas pipe 90 and the turbo chargers 110 and 120 through joints.

The flow rate control valve 30 is installed in the branch pipe 20 to adjust a flow rate of the exhaust gases transferred to the turbo chargers 110 and 120 through the branch pipe 20, and an opening degree of the flow rate control valve 30 is controlled by the control unit 80.

The EGR valve 40 is installed in the EGR exhaust gas pipe 90 connected to the EGR cooler 10, and an opening degree (or opening rate) of the EGR valve 40 is controlled to adjust an amount of exhaust gases circulated to the engine 1.

The opening degree of the EGR valve 40 may be controlled by a separate EGR control unit or the control unit 80, and when a separate EGR control unit controls an opening degree of the EGR valve 40, the control unit 80 receives information on an opening degree (or opening rate) of the EGR valve 40 from an EGR control unit and recognizes the information.

The water temperature sensor 50 is adapted to measure a temperature of engine cooling water supplied from the EGR cooler 10 or the engine, and is installed to measure a temperature of the engine cooling water in the vehicle.

The load detection sensor 60 is adapted to measure engine loads such as an RPM and a torque of the engine, and is installed to measure a load of the engine in the vehicle.

The atmosphere temperature sensor 70 is adapted to measure a temperature of the atmosphere, and is installed to measure a temperature of the atmosphere in the vehicle.

The control unit 80 is adapted to control an opening degree of the flow rate control valve 30, and controls an opening degree of the flow rate control valve 30 based on an opening degree of the EGR valve 40, a temperature of engine cooling water, a temperature of the atmosphere, and a load of the engine.

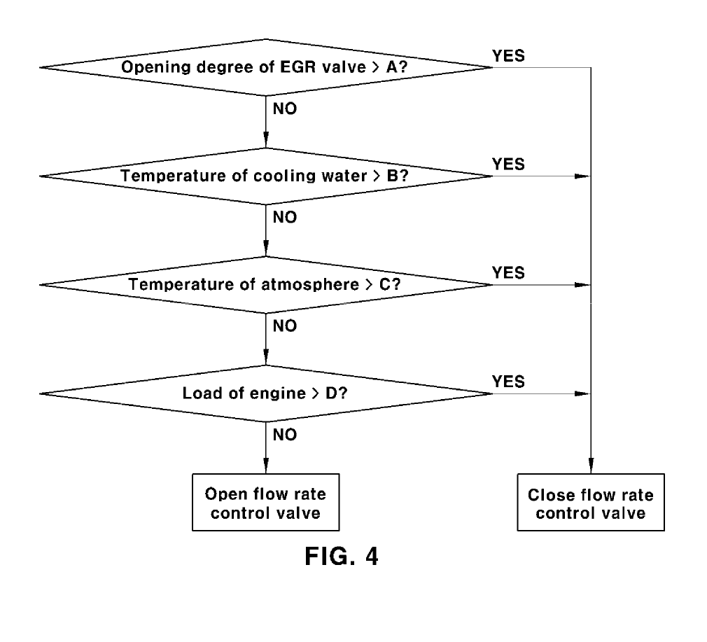

As shown in FIG. 4, the control unit 80 opens the flow rate control valve 30 only when an opening degree of the EGR valve 40 satisfies a condition as it becomes a reference value or below, a temperature of engine cooling water satisfies a condition as it becomes a reference value or below, a temperature of the atmosphere satisfies a condition as it becomes a reference value or below, and a load of the engine satisfies a condition as it becomes a reference value or below.

That is, the control unit 80 opens the flow rate control valve 30 by a predetermined opening degree only when all of the opening degree of the EGR valve 40, the temperature of the engine cooling water, the temperature of the atmosphere, and the load of the engine satisfy the predetermined conditions (for example, the reference values or below).

If even one of the opening degree of the EGR valve 40, the temperature of the engine cooling water, the temperature of the atmosphere, and the load of the engine does not satisfy the conditions, the control unit 80 closes the flow rate control valve 30 by switching off the flow rate control valve 30.

Hereinafter, the exhaust gas recovery apparatus of an EGR cooler for a vehicle according to various other embodiments of the present invention will be described, and the same configurations and functions as those of the above-described embodiment may be omitted.

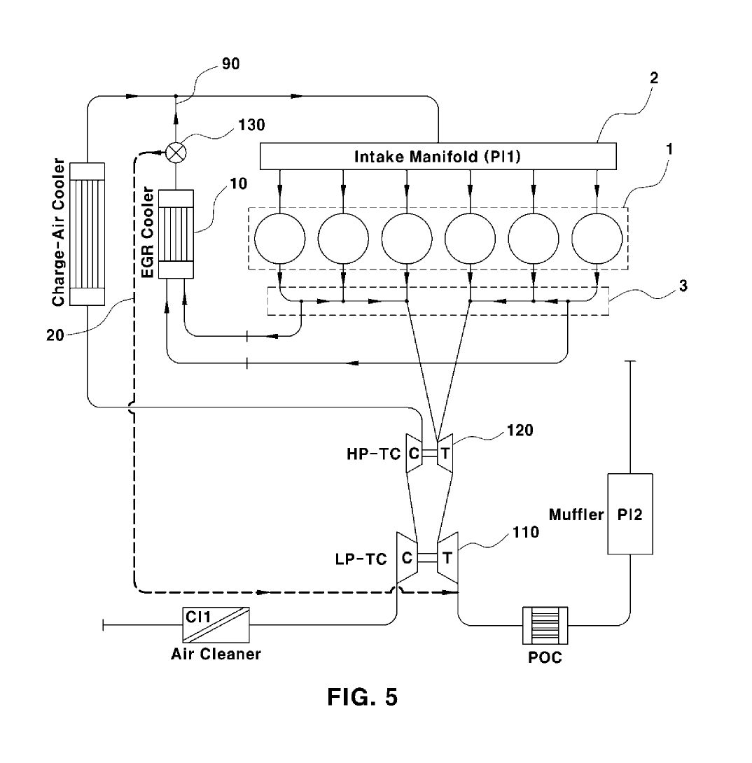

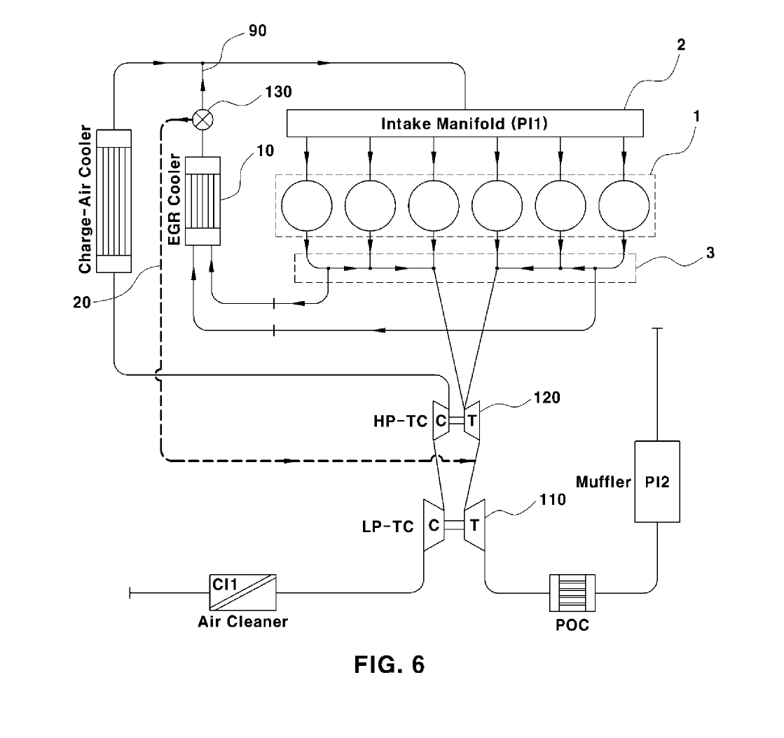

FIG. 5 is a schematic diagram showing an exhaust gas recovery apparatus of an EGR cooler for a vehicle according to a third embodiment of the present invention. FIG. 6 is a schematic diagram showing an exhaust gas recovery apparatus of an EGR cooler for a vehicle according to a fourth embodiment of the present invention.

As shown in FIG. 5, the exhaust gas recovery apparatus of an EGR cooler for a vehicle according to the present invention may include an EGR cooler 10, a branch pipe 20, a direction control valve 130, and a control unit 80.

If some exhaust gases discharged from the engine 1 are introduced into the EGR cooler 10, the EGR cooler 10 cools the exhaust gases and circulates the exhaust gases to the engine 1.

The branch pipe 20 is branched from the EGR exhaust gas pipe 90 and is connected to the turbo chargers 110 and 120, and some exhaust gases in the EGR cooler 10 are transferred to the turbo chargers 110 and 120.

As shown in FIG. 5, the branch pipe 20 is branched from the EGR exhaust gas pipe 90 connected to a rear end of the EGR cooler 10 and is connected to a rear end of a low pressure turbo charger 110.

As shown in FIG. 6, the branch pipe 20 may be connected to a front end of the low pressure turbo charger 110 or a rear end of a high pressure turbo charger 120.

The direction control valve 130 is adapted to control a flow direction of the exhaust gases discharged from the EGR cooler 10, and is installed at a connection point of the branch pipe 20 and the EGR exhaust pipe 90 to adjust an amount of exhaust gases flowing to the branch pipe 20 and the EGR exhaust gas pipe 90. The direction control valve 130 may include an electric three-way valve.

The control unit 80 is adapted to control an operation of the direction control valve 130, and controls an operation of the direction control valve 130 based on an EGR opening degree (or opening rate).

Here, the EGR opening rate represents an amount of exhaust gases circulated to the engine, and is determined by the control unit 80 or a separate EGR control unit for EGR control.

When a separate EGR control unit determines an EGR opening rate, the control unit 80 receives information on an EGR opening rate from the EGR control unit.

The control unit 80 controls an operation of the direction control valve 130 based on the EGR opening rate to control a flow rate of the exhaust gases flowing to the branch pipe 20.

That is, if the EGR opening degree is determined, the control unit 80 controls an inlet opening rate of the branch pipe 20 through Equation 1.

Inlet opening rate (%)=100%−EGR opening rate (%) (Equation 1)

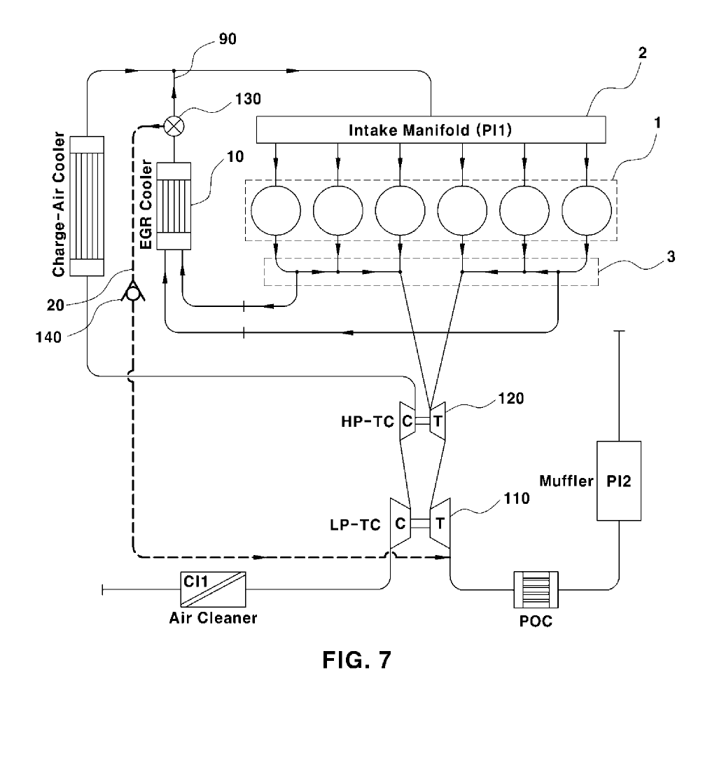

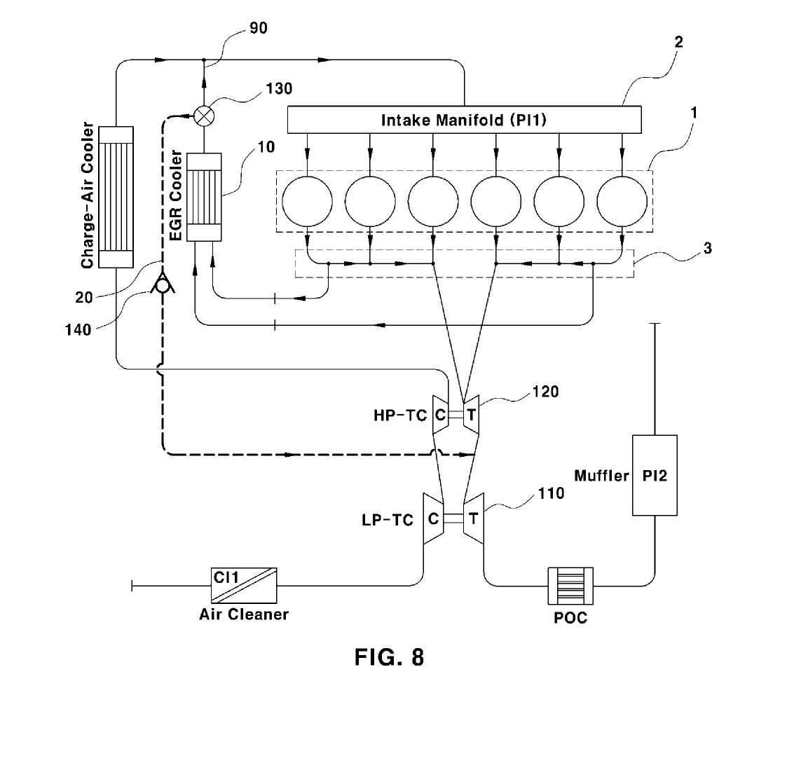

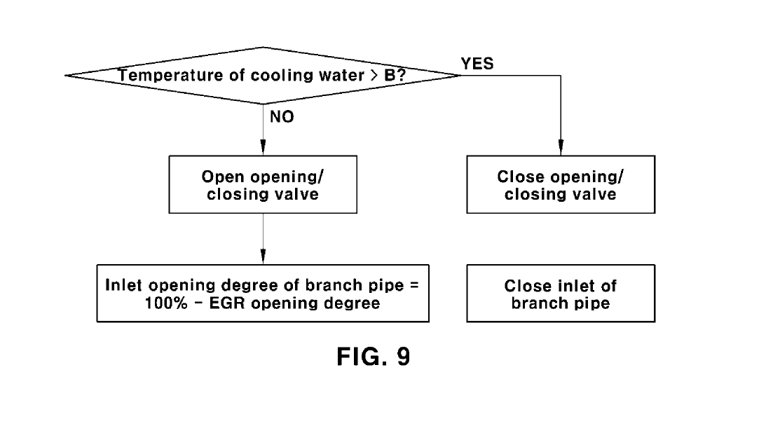

FIG. 7 is a schematic diagram showing an exhaust gas recovery apparatus of an EGR cooler for a vehicle according to a fifth embodiment of the present invention. FIG. 8 is a schematic diagram showing an exhaust gas recovery apparatus of an EGR cooler for a vehicle according to a sixth embodiment of the present invention. FIG. 9 is a flowchart showing an operation condition of the exhaust gas recovery apparatuses of an EGR cooler for a vehicle according to the fifth and sixth embodiments of the present invention.

As shown in FIG. 7, the exhaust gas recovery apparatus of an EGR cooler for a vehicle according to the present invention may include an EGR cooler 10, a branch pipe 20, a direction control valve 130, an opening/closing valve 140, a water temperature sensor 50, and a control unit 80.

If some exhaust gases discharged from the engine 1 are introduced, the EGR cooler 10 cools the exhaust gases and circulates the exhaust gases to the engine 1.

The branch pipe 20 is branched from the EGR exhaust gas pipe 90 connected to a rear end of the EGR cooler 10 and is connected to the turbo chargers 110 and 120, and transfers some exhaust gases in the EGR cooler 10 to the turbo chargers 110 and 120.

As shown in FIG. 7, the branch pipe 20 may be branched from the EGR exhaust gas pipe 90 and may be connected to a rear end of a low pressure turbo charger 110, or as shown in FIG. 8, the branch pipe 20 may be connected to a front end of the low pressure turbo charger 110 or a high pressure turbo charger 120.

The direction control valve 130 is adapted to control a flow direction of the exhaust gases discharged from the EGR cooler 10, and is installed at a connection point of the branch pipe 20 and the EGR exhaust gas pipe 90 to adjust inlet opening rates of the branch pipe 20 and the EGR exhaust gas pipe 90 and adjust an amount of exhaust gases flowing to the pipes 20 and 90. The direction control valve 130 may include an electric three-way valve.

The opening/closing valve 140 is installed in the branch pipe 20 to control a flow of the exhaust gases transferred to the turbo chargers 110 and 120 through the branch pipe 20, and performs an on/off operation according to a result obtained by comparing a temperature of engine cooling water and a reference value.

The water temperature sensor 50 is adapted to measure a temperature of engine cooling water, and is connected to the control unit 80 such that signals can be transmitted from the water temperature sensor 50 to the control unit 80 as shown in FIG. 2, to provide detected information to the control unit 80.

The control unit 80 is adapted to control an operation of the direction control valve 130 and an operation of the opening/closing valve 140, and opens the opening/closing valve 140 and controls an operation of the direction control valve 130 based on the EGR opening rate (or opening degree) at the same time if a temperature of engine cooling water is a reference value or below, and closes the opening/closing valve 140 and forces the direction control valve 130 to close an inlet of the branch pipe 20 if a temperature of the engine cooling water is above a reference value.

Here, the EGR opening rate represents an amount of exhaust gases circulated to the engine, and is determined by the control unit 80 or a separate EGR control unit for EGR control.

When the separate EGR control unit determines the EGR opening rate, the control unit 80 receives information on the EGR opening rate from the EGR control unit.

The control unit 80 controls an operation of the direction control valve 130 based on the EGR opening rate to control a flow rate of the exhaust gases flowing to the branch pipe 20.

That is, if the EGR opening rate is determined, the control unit 80 controls an inlet opening rate of the branch pipe 20 through Equation 2.

Inlet opening rate (%)=100%−EGR opening rate (%) (Equation 2)

Meanwhile, the control unit 80 may receive detection information (a load of the engine and a temperature of the atmosphere) from a load detection sensor 60 for measuring a load of the engine and an atmosphere temperature sensor 70 for measuring a temperature of the atmosphere to determine whether the opening/closing valve 140 is to be opened.

Then, the control unit 80 opens the opening/closing valve 140 only when all of the temperature of engine cooling water, the temperature of the atmosphere, and the load of the engine are below predetermined values or below.

For convenience in explanation and accurate definition in the appended claims, the terms “front” or “rear”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust gas recovery apparatus of an exhaust gas recirculation (EGR) cooler for a vehicle, the apparatus comprising:
a branch pipe for transferring exhaust gases discharged from the EGR cooler to a turbo charger;
a flow rate control valve installed in the branch pipe, for adjusting a flow rate of the exhaust gases; and
a control unit for controlling an opening degree of the flow rate control valve.

2. The apparatus of claim 1, further comprising:
an EGR valve installed in an EGR exhaust gas pipe connected to the EGR cooler, for adjusting an amount of the exhaust gases circulated to the engine;
a water temperature sensor for measuring a temperature of engine cooling water;
a load detection sensor for measuring a load of the engine; and
an atmosphere temperature sensor for measuring a temperature of the atmosphere,
wherein the water temperature sensor, the load detection sensor, and the atmosphere temperature sensor provides the measured temperatures and load to the control unit.

3. The apparatus of claim 1, wherein the branch pipe is branched from an EGR exhaust gas pipe and is connected to a front end or a rear end of the turbo charger.

4. The apparatus of claim 2, wherein the control unit opens the flow rate control valve only if all of an opening degree of the EGR valve, the temperature of the engine cooling water, the temperature of the atmosphere, and the load of the engine satisfy predetermined conditions.

5. The apparatus of claim 2, wherein the control unit controls the opening degree of the flow rate control valve based on an opening degree of the EGR valve, the temperature of the engine cooling water, the temperature of the atmosphere, and/or the load of the engine

6. An exhaust gas recovery apparatus of an EGR cooler for a vehicle, the apparatus comprising:
a branch pipe for transferring exhaust gases discharged from the EGR cooler to a turbo charger;
a direction control valve installed at a connection point of the branch pipe and an EGR exhaust gas pipe, for adjusting a flow direction of the exhaust gases; and
a control unit for controlling an operation of the direction control valve.

7. The apparatus of claim 6, wherein the branch pipe is branched from the EGR exhaust pipe and is connected to a front end or a rear end of the turbo charger.

8. The apparatus of claim 6, wherein the control unit controls the operation of the direction control valve based on an EGR opening rate.

9. The apparatus of claim 6, wherein the direction control valve includes an electric three-way valve.

10. An exhaust gas recovery apparatus of an EGR cooler for a vehicle, the apparatus comprising:
a branch pipe for transferring exhaust gases discharged from the EGR cooler to a turbo charger;
a direction control valve installed at a connection point of the branch pipe and an EGR exhaust gas pipe, for adjusting a flow direction of the exhaust gases;
an opening/closing valve installed in the branch pipe, for controlling a flow of the exhaust gases; and
a control unit for controlling an operation of the direction control valve and an operation of the opening/closing valve.

11. The apparatus of claim 10, wherein the branch pipe is branched from the EGR exhaust pipe and is connected to a front end or a rear end of the turbo charger.

12. The apparatus of claim 10, further comprising:
a water temperature sensor for measuring a temperature of engine cooling water, wherein the water temperature sensor provides the measured temperature to the control unit.

13. The apparatus of claim 10, wherein the control unit opens the opening/closing valve and controls the operation of the direction control valve based on an EGR opening rate if a temperature of engine cooling water is equal to or less than a reference value.

14. The apparatus of claim 10, wherein the direction control valve includes an electric three-way valve.

15. The apparatus of claim 4, wherein the control unit controls the opening degree of the flow rate control valve based on the opening degree of the EGR valve, the temperature of the engine cooling water, the temperature of the atmosphere, and/or the load of the engine
